(19) United States
(12) Patent Application Publication
(10) Pub. No.: US 2005/0149358 A1
(43) Pub. Date: Jul. 7, 2005

(54) RFID tracking of anesthesiologist and patient time

(75) Inventors: John J. Sacco, Fayetteville, NY (US); Brett B. Greenky, Manlius, NY (US)

Correspondence Address: BERNHARD P. MOLLDREM, JR., 224 HARRISON STREET, SUITE 200, SYRACUSE, NY, 13202, US

(73) Assignee: Lisa M. Sacco and Lynn Greenky

(21) Appl. No.: 10/752,070

(22) Filed: Jan. 6, 2004

(51) Int. Cl. G06F 17/60

(52) U.S. Cl. 705/2; 340/870.01

(57) ABSTRACT

RFID-based system for tracking billable anesthesiology time in a surgical environment employs hand-held RFID reader devices that record and store timed anesthesia events for each surgical patient. Each patient is assigned a reader device, uploaded with patient data. Each anesthesiology professional has an identifying RFID transponder, and room transponders are located on wall or doorway of each room in the surgical suite. A download cradle is used for downloading the patient data collected during surgery to a central computer. The reader devices are synchronized to a high-accuracy clock, eliminating time accounting problems associated with concurrency and discontinuous time.

### BACKGROUND OF THE INVENTION

This invention concerns a system and method for tracking the billable time of anesthesiology professionals and is more particularly concerned with a technique for use by anesthesia departments in hospitals and surgery centers for data management and billing in the peri-operative environment, reducing the time spent compiling patient data in the peri-operative environment, providing for improved billing accuracy, maximizing reimbursement and optimizing insurance payment profiles.

The demands for greater efficiency in health care delivery and maximized reimbursement have never been more crucial to the prosperity of the hospital or the independent health care providers.

Health care providers administering critical care to patients are often required to spend a burdensome amount of time documenting care, whether by hand, on paper, or by inputting data into a computer. There exists a need for real-time, wireless tracking of patients that is less error-prone than existing systems, and which provides for more efficient care and for more accurate billing that complies with increasing government regulation.

The system presently in place in hospital operating rooms and other critical care areas for tracking patient care are cumbersome and prone to error. Hospitals have been routinely criticized for remaining paper-dependent in the midst of a technological revolution. Manual and paper-based systems are no longer viable. The costs and inefficiencies associated with those systems are too high and the risk of error is unacceptable.

In addition to the enormous time wasted by health care professionals required to document by hand or computer every aspect of care and the time and place in which it occurs, the present manual systems continue to drive up the cost of health care. Insurance companies often deny otherwise valid claims because of minor errors in time entry.

Although there is a significant amount of medical-related software on the market, none of it adequately addresses the need to capture time-dependent data in the peri-operative environment for the purposes of data management, billing and improvement of patient care. Consequently, many billable anesthesia events go unrecorded, poorly recorded, or erroneously recorded in the peri-operative environment.

Time spent by hospitals, physicians and staff recording and properly identifying billing data for insurance and government collection is overwhelming. Despite the amount of time spent collecting and disseminating the data to the proper entities, hospitals and anesthesiologists find themselves being denied payment and subject to government inquiry by reason of data-entry errors. As hospitals and anesthesiologists seek to recover payment for legitimate time spent with patients and to comply with all government regulations, they will look to streamline their operations, secure business processing efficiencies and achieve tangible cost savings, all while maximizing positive cash flow.

There are two interdependent classes of health care providers that suffer under the present system of date recording in the peri-operative environment. They are:

(1) Anesthesiologists; and (2) The hospitals and surgery centers in which they practice.

I. Anesthesiologists

The present system fails anesthesiologists and their support staff in five distinct areas:

A. Errors in recording; B. Errors in timekeeping; C. Increased invoice-to-remittance lag time; D. Requires shift of focus from patient management to data management; and E. Negatively affects medical insurance payment profiles.
A. Errors in Recording:
   Errors occur in the peri-operative environment by reason of:

I. Failure to Enter Data

II. Error in Entering Data
I. Failure to enter data in accordance with private insurance company requirements;
ii. Failure to enter data in accordance with government Medicaid and Medicare requirements;
iii. Failure to enter data in accordance with individual HMO requirements; and
iv. Failure to enter data in accordance with newly released government HIPPA confidentiality requirements.

III. Transcription Errors.
B. Errors in Timekeeping:

Time keeping errors in the peri-operative environment are extensive.

I. A recent study determined that 86% of hospital wall clocks are out-of-sync. The effects of out-of-sync timekeeping in the peri-operative environment are manifold. Countless bills are compromised and therefore rejected by reason of unit charge inaccuracies and perceived concurrent time inaccuracies.

II. Inability to properly account for time spent with a patient also leads to failure to bill for justifiably billable time (discontinuous time).

III. Critical events in the operating room are frequently not recorded in a consistent, accurate and timely manner.
C. Increased Invoice-to-remittance Lag Time.

As a result of discontinuous and concurrent timing irregularities, initial invoices are rejected by insurance companies requiring reprocessing and resubmittal.
D. Shift of Focus from Patient Management to Data Management.

Health care providers administering critical care to patients are too often required to spend a great deal of time documenting care, whether by hand, on paper, or inputting data into a computer. Such activity takes up precious time in a fluid and ever-changing environment that, by definition, is treating people in need of immediate or emergent care.

II. Hospitals and Surgery Centers:

The system presently in place in hospitals and surgery centers requires countless manhours collecting data and analyzing efficiency issues. The data itself are collected and entered by hand. This often renders the data subject to dispute and inherently unreliable; consequently the conclusions reached by analysis of the data are similarly questionable.

### OBJECTS AND SUMMARY OF THE INVENTION

It is an object of this invention to provide a solution to the foregoing problem for anesthesia departments in hospitals and surgery centers located in the United States.

It is a related object to provide a system that satisfies the demands of Medicare, Medicaid, HMO's, the Federal Government and HIPPA, Health Care Facilities, and the Anesthesia Care Teams by significantly improving the methods of record keeping.

It is a more specific object to provide a technique that introduces RFID technology to the hospital setting for the purposes of recording time-related events. The term RFID (radio frequency identification) describes the use of radio frequency signals to provide automatic identification of items. RFID equipment is a part of the Automatic Identification and Data Collection (AIDC) industry that includes bar code, electronic data interchange (EDI) and magnetic stripe technology.

Another important object is to provide state-of-the art solutions to the needs identified for both anesthesia groups and the hospitals and surgery centers they serve for accurate real-time record keeping regarding patient care in the peri-operative environment, and to employ RFID technology to obtain a secure and virtually contact-less solution for data capture.

A more specific object is to provide an anesthesiologist a time tracking system that will accurately reflect the identity of the patient including all relevant medical data as well as the identities of all health care providers who assisted in the patient's care; that is, it is an object to provide a system that will “track” the time and place the service was performed and the duration of the service; allowing for accurate billing, elimination of discontinuous time and concurrency problems for anesthesia providers, thereby protecting insurance payment profiles, as well as ensuring compliance with government regulations.

Additionally, it is an object to provide the ability to retrieve data and analyze it to determine both efficient and inefficient aspects of care.

In preferred embodiments of this invention, the system applies RFID technology.

RFID is a flexible technology that is convenient, easy to use, and well suited for automatic operation. It combines advantages not available with other identification technologies. RFID can be supplied as read-only or read/write and has a 2K memory.

Unlike bar coding, it does not require contact or line-of-sight to operate. RFID can function under a variety of environmental conditions, and provides a high level of data integrity. In addition, because the technology is difficult to counterfeit, RFID provides a high level of security. RFID technologies provide unique solutions to difficult logistical tracking of inventory or equipment, particularly in applications where optically based systems fail and when read/write capabilities are required. The technology is stable, and evolving, with open architectures becoming increasingly available.

Radio frequency (RF) refers to electromagnetic waves that have a wavelength suited for use in radio communication. Radio waves are classified by their frequencies, which are expressed in kilohertz, megahertz, or gigahertz. Radio frequencies range from very low frequency (VLF), which has a range of 10 to 30 kHz, to extremely high frequency (EHF), which has a range of 30 to 300 GHz.

RFID is presently used in applications such as electronic toll collection (New York State E-Z Pass), railway car identification and tracking, intermodal container identification, asset identification and tracking, item management for retail, health care, and logistics applications access control, animal identification, fuel dispensing loyalty programs, and automobile immobilizing (security).

According to an aspect of this invention, an anesthesiology time tracking system assists in tracking and recording of billable time of anesthesiology professionals including anesthesiologists, certified RN anesthetists, and other professionals. The amount of time the professional spends with a surgical patient is tracked and recorded throughout a surgery suite that includes at least one pre-induction room, at least one surgical operating room, and at least one post-anesthesiology care unit room. Typically, the patient is wheeled on bed a between rooms, and a reader, i.e., a portable hand-held data collection device, accompanies the patient in the suite and keeps accurate track of anesthesiology professional that provide services to the patient.

In this system, there are a number of such hand held portable data collection devices, and each includes an RFID reader for communicating with a set of RFID transponders. The portable data collections devices also include means for inputting patient information and the identity of the head surgeon and type of procedure being performed. There are a plurality of personal RFID transponders in a number sufficient to assign a respective one to each of the anesthesiology professionals. These are all coded to identify the professional when the transponder is held within a predetermined short distance from a given one of said data collection devices. There are also room RFID transponders, each being mounted on a wall or doorway of a the pre-induction room; the operating room; and the post-anesthesiology care unit room, respectively. A carrier or holder is provided on the bed of each patient. This permits the assigned data collection reader device to travel with the patient throughout the surgical suite, but allows the device to be removed from the holder so that it can be held or swept past the associated room transponders when the patient is moved through the pre-induction, operating, and post-anesthesiology care unit rooms, both when the patient enters and when the patient leaves the room. The system also includes a download station in which a cradle is provided. The hand-held data collection devices can be placed into the cradle following completion of the anesthesia services, and data stored on the data collection device is downloaded to a server computer to capture times during the procedure that each such anesthesiology professional was present in each said room during the procedure. This ensures that the events for each professional will be tracked for each patient and for each room. The system will account accurately for anesthesia start time, total surgical time, discontinuous time, pre-induction time, and post-anesthesia care time. The various data collection devices each include a clock, and these are all synchronized with a common high-precision clock. The devices can be synchronized during downloading, when uploading patient information, or can be synchronized continuously using a wireless connection. Preferably, there is a station within the pre-induction room where patient identity and other relevant patient information is uploaded onto the data collection device or reader that will accompany the patient during surgery. The data collection device can have a keyboard or another set of buttons adapted to permit the anesthesiology professionals to enter data to identify and record the identity of the head surgeon and the surgical procedure being performed. The data collection devices also may include a screen for displaying the data collected.

A computer station is also preferably associated with the download station, and includes a capability to permit the anesthesiologist to correct or change the data that may have been entered erroneously.

The technique of this invention has clear advantages in reducing or eliminating anesthesiology time recording and billing:

The technique of this invention provides accurate identification of the patient and all relevant data, accurate identification of all health care personnel providing peri-operative care to the patient, and accurate integration of time-related data into existing medical record software.

The technique of this invention reduces errors in timekeeping. All timekeeping data will be synchronized through a central server. Synchronization of all timekeeping data will reduce the number of payment refusals by reason of concurrency problems involved in anesthesia care, eliminate inaccuracies regarding time of procedures during all aspects of operative and critical care, facilitate capture of discontinuous billing times, and optimize MD insurance payment profiles.

The technique of this invention allows health care workers to shift focus from data management to patient management by achieving virtually hands free, unobtrusive documentation of essential information allowing health care providers to focus on the clinical situation and provide cost-effective quality care.

By implementing this technique, the hospital can initiate ongoing quality improvements in operating room efficiency. Data, which are at present not available to the administration, as well as data only available after considerable manual extraction, will now be available in real time and on a going-forward basis. This will allow, among other things, the ability to focus on cost saving measures, patient transit time delays, surgeon specific cost profiles, procedure specific cost profiles, and so forth. For example, laparoscopic cholecystectomy cost could be examined, comparing variables such as surgeon, shift, patient weight, etc. The cost savings alone of manpower reduction to the operating room and recovery room nurse managers in processing reports involving ongoing efficiency monitors would pay for the systems installation and maintenance.

The technique of this invention has several specific advantageous capabilities; namely, to provide the ability to track overall turnaround times as well as personnel who treated the patient in the peri-operative theater, to provide for accurate billing, compliant with government regulations, to provide paperless storage of data, and to satisfy HIPPA confidentiality standards.

A preferred embodiment utilizes RFID readers and transponders that operate at 13.56 MHZ. Although RFID readers require an active power source (battery or wall outlet), the transponders incorporate a passive technology. The reader emits a low-level radio frequency magnetic field that energizes the tag. The tag then sends back identification date stored in its integrated circuit. This data is then decoded by the reader.

The radio frequency used is ISO 15693 compliant. Compliancy offers increased security and authentication, read-write programmability and inter-operability across all suppliers and applications. The invention does not require reliance upon a single supplier of hardware to operate the system and can benefit from market competition for the non-proprietary aspects of the system. Typically, each transponder has 2K of memory and as a result of the ISO standardization, each transponder has a unique identification number that only the manufacturer can assign. Finally, each transponder has a 128-bit encryption so that date on the transponder is capable of being protected at the highest level of security available today for data encryption. These features are particularly important in the health care field in light of the newly promulgated HIPPA standards concerning patient confidentiality.

The radiation power levels and frequency range here are many times below the limits set by even the most conservative health regulatory agencies and study organizations.

As for the hardware and software requirements in the hospital environment, the software can be an MS-Windows based proprietary system. The hardware required may include a combination of commercially available merchandise as well as value-added commercial merchandise. The commercially available hardware required for the system including, readers, holders, data ports, tags and wristbands makes the cost within reach of the consumer and any needed replacement available in a timely fashion.

The technique of this invention provides that the entrance and exit of each room in the peri-operative suite will be outfitted with RFID transponders. Each room or wall transponder is uniquely identified as to location.

Each necessary health care worker will be supplied with a personal RFID transponder that uniquely identifies him or her.

An RFID reader will be assigned to each operative patient that will contain all relevant demographic data as well as accurately reflect the time of day. The reader will be placed within a holder on the patient's bed and follow the patient through the operative experience.

Docking stations will be placed in the recovery room for downloading the data and eventual erasure thus readying the reader for reuse.

The technique can be employed in an anesthesiology/surgery environment explained simply here. Patient (“P”) is diagnosed with a problem that requires the use of anesthesia administered by certified medical personnel—a Medical Doctor (an Anesthesiologist) and/or a Certified Registered Nurse Anesthetist.

Prior to surgery, P is required to provide the hospital with various demographic and insurance data as well as any other information relevant to the upcoming surgery.

P thereafter arrives at the hospital for surgery and is properly gowned and assigned a bed or stretcher. P is then transferred to pre-induction and prepared for surgery. At pre-induction, P is assigned a Reader, which is uploaded with all relevant data from a docking station located in pre-induction. The reader is then presented to the one of the peri-operative room transponders thereby noting P's location. The reader will also properly record the time of day at the moment of presentation to the transponder. The reader will then be attached to P's bed.

P is now “in process”. The Anesthesiologist assigned to P may begin anesthesia care in the pre-induction area. He will present his unique transponder to P's reader, thereby noting the place and time of his interaction. The patient will then either remain in the pre-induction area until the operating room is ready or he will be taken directly to the operating room. If the patient is caused to wait for a period of time after the anesthetic has been delivered, the anesthesiologist will present his transponder to P's reader thereby noting discontinuous time.

P is taken to the operating room where the reader is presented to the operating room transponder thereby providing accurate, real-time recording of the entry of the patient in the room. The reader previously attached to P's bed is moved to the operating table. As each Anesthesiologist and each CRNA enters or exits the operating room he or she will present his transponder to P's reader thereby providing accurate real-time recording of the identities of each such person and the time of their entry or exit. If the health care worker exits the operating room in which P is being treated and enters a second operating room, the health care worker will similarly present his transponder to the second patient's reader. The identity and location of the health care worker will be properly noted as well as the time, which will eliminate all issues of concurrency.

P's reader will have the capability of recording the surgical procedure being performed and the identity of the head surgeon. At the completion of the operation, P is removed from the operating room at which time his or her reader is presented to the operating room transponder, noting exit from the operating room and the time of exit. Upon entrance to the PACU (Recovery Room), P's reader is presented to the PACU transponder, once again noting place and time of entry. Billable anesthesia time ends when the patient is stable, and discharged from the recovery room. At that time the anesthesiologist will remove the reader from P's bed and place it in a docking station whereupon data is downloaded from the reader to a dedicated server. All the data is encrypted and complies with all governmental requirements for accuracy and privacy. All errors in recording can be corrected with an override feature that is incorporated into the software. Back-up procedures will be available in the event of system failure.

Once in the server, the data is made available for integration into anesthesia billing and hospital use by properly identified individuals.

This technique, employing RFID, has significant advantages over optical, bar code, or magnetic stripe based systems. Bar coding is an inferior technology to RFID for the purposes of data capture. The optical nature of bar code requires labels to be “seen” by lasers. Line-of-sight between label and reader is difficult, impractical, or even impossible to achieve in hospital environments. In order to function properly, a bar code reader must have clean, clear optics, the label must be clean and free of abrasion, and the reader and label must be properly oriented with respect to each other. RFID technology enables tag reading from a greater distance, even in harsh environments.

In addition, the information imprinted on a bar code is fixed and cannot be changed. RFID tags, on the other hand, have electronic memory similar to what is in a computer or digital camera to store information about the inventory or equipment. This information can be dynamically updated. Further, RFID tags are extremely difficult to duplicate, and are therefore more secure. RFID tags offer a completely contact-less solution for data capture, security, access management and inventory management.

A typical implementation for a small or mid-size hospital could include the following equipment:

| Element | Description | Units |
|---|---|---|
| Palm Reader | Travel w/Patient | 36 |
| Mullian Readers | Encodes Transponder | 6 |
| Microsoft SQL | Database | 1 |
| Installation/Testing | Set up & Test | 2 |
| Training | 2 Session/Day | 2 |
| Room Transponders | Stationery Units | 20 |
| Reader Pouches | Holding Devices | 36 |
| Care Provider Transponders | Worn by DR's/RN's | 100 |
| Standard Software | Primary System | 11 |
| Integration Software | Project Specific | 1 |

The above and many other features and advantages of the invention will become apparent from the ensuing detailed description of a preferred embodiment, which is described in connection with the accompanying Drawing figures.

### BRIEF DESCRIPTION OF THE DRAWING

FIG. 1 is a schematic view of a hospital operating area, with pre-induction room, operating room, and post-anesthesia patient care unit, showing incorporation of an embodiment of the invention.

FIG. 2 shows a portable, hand-held patient reader device according to this embodiment.

FIG. 3 shows a badge as worn by an anesthesiology professional and incorporating an RFID transponder according to this embodiment.

FIG. 4 shows a wall transponder of this embodiment.

FIG. 5 shows a patient rolling bed incorporating a holder for the patient reader device.

FIG. 6 is a schematic view for explaining a download process according to this embodiment.

FIGS. 7 shows data tables produced by the system which can be displayed on a computer screen or may be printed.

FIG. 8 is a diagram for explaining the process of downloading healthcare professional and location ID data to the RFID transponders.

FIG. 9 is a diagram for explaining the process of downloading patient information to the patient reader device.

FIG. 10 is a diagram for explaining the process of reading and uploading transaction data involving the patient and health care provider(s) during a surgical procedure.

### DETAILED DESCRIPTION OF A PREFERRED EMBODIMENT

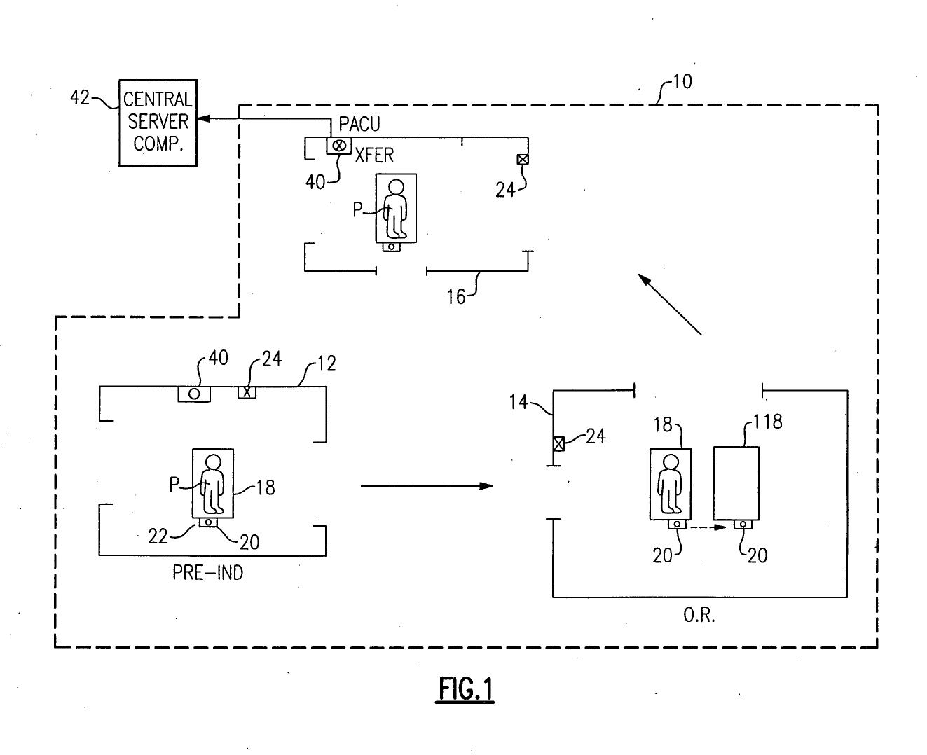

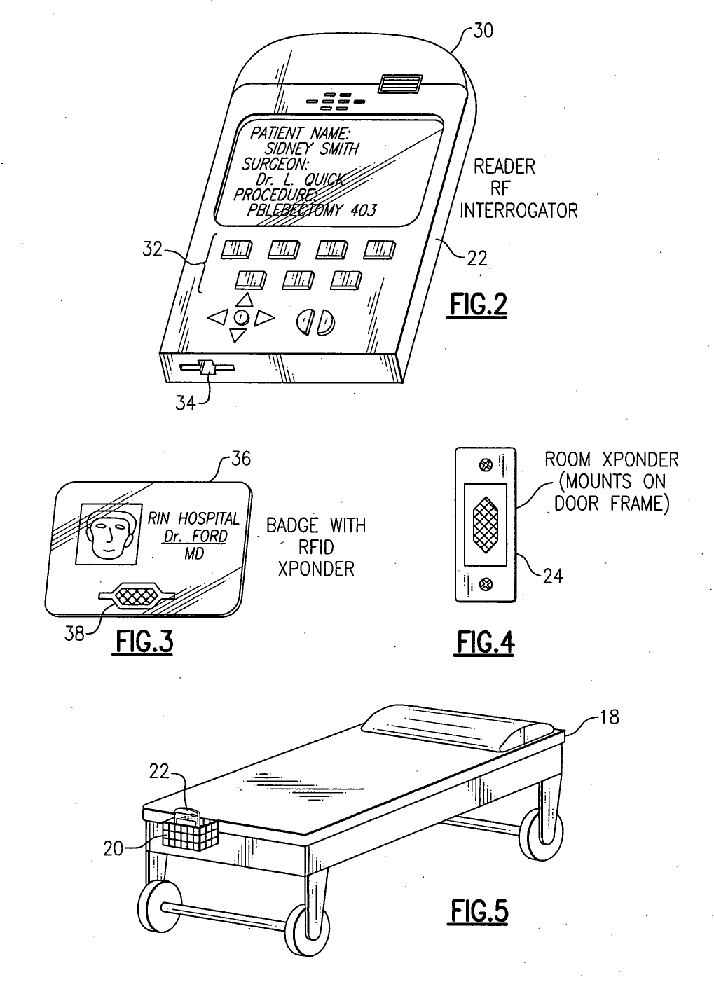

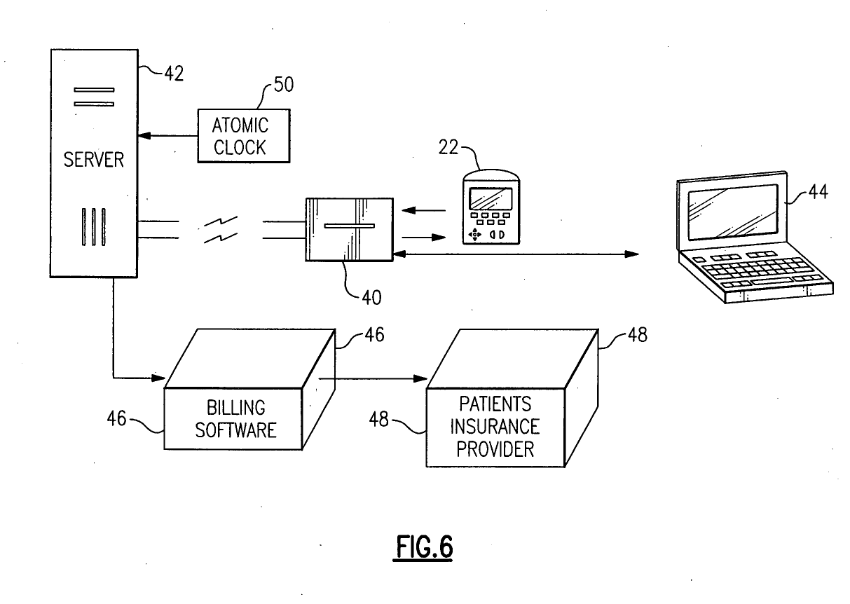

With reference to the Drawing, and initially to FIG. 1 thereof, a surgical suite 10 in a hospital or surgical center typically has a number or patient treatment rooms within it, and here are shown a pre-induction room 12, of which there may be only one or several, an operating room or OR 14, and a post-treatment room, i.e., post-anesthesia care unit or PACU 16. Typically, the patient P arrives at the pre-induction room 12 and is placed on a rolling bed 18. This is the location where the anesthesiologist first meets with the patient, and may administer a block or other anesthesia treatment. The patient's bed has a receptacle or holder 20 mounted at one end. When the patient arrives in the pre-induction room, he or she is assigned a reader device 22, i.e., a hand-held data collection and storage unit with an RFID transceiver as discussed above, and the patient's name and vital data are uploaded into it. Then the reader device 22 is placed into the holder 20 on the patient bed 18, so that the device 22 will accompany the patient throughout the surgery. The RFID transceiver of the reader device 22 typically has a low power with a range of a few inches, and interrogates associated RFID transponders that are placed within a few inches of the device. The low power ensures that the readers do not interfere electronically with any of the surgical or life support equipment.

In the pre-induction room 12 and in each of the other rooms throughout the surgical suite 10 there are wall transponders 24, which may be mounted in a doorway of the room or on a wall. When the patient P is moved, i.e., rolled or wheeled on the bed 18 from the pre-induction room 12, a member of the staff will take the reader device 22 out of the holder 20, and sweep it past the transponder 24 in the pre-induction room 12. The reader device 22 then records the time that the patient leaves that room. Then the patient P is wheeled down to the assigned operating room 14, and the staff member again takes the reader device 22 and sweeps it past the wall transponder 24 in the OR 14. This occurs likewise for when the patient is brought from the OR 14 to the PACU 16, and when the patient is released from the PACU. Thus, the time is recorded when the patient P is present in each of the various rooms in the surgical suite, and when the patient leaves that room. At the OR 14, the patient P may be transferred to an operating table 118, and the reader device 22 can be transferred also to the operating table 118.

FIG. 2 illustrates a typical RFID reader device 22 of one embodiment of this invention. Here, the device 22 is a hand-held data storage and display device, e.g., in the nature of a personal digital assistant. The device 22 has a low-power RFID transceiver 30 attached to it or incorporated into it, as well as keyboard or an array of pushbuttons or keys 32. The latter can be used by the anesthesiology professional for keying in patient or procedural information. An LCD screen 33 may provide for confirmation of correct data entry, as well as confirmation of identity of patient, surgical procedure, and health care person(s) present. At the base is a connector port 34, which is used for uploading or downloading data, as described later. This can alternatively be a wireless connection.

FIG. 3 illustrates one example of a personal RFID transponder 36, here in the form of a card or badge that is worn by the anesthesiologist, CRNA, or other anesthesiology professional. The badge has a small RFID chip 38 or integrated circuit embedded in it or attached to it. As the anesthesiologist or CRNA arrives and is present with the patient, he or she places his or her transponder badge 36 near the patient reader device 22, and his or her presence is automatically captured by the device, so that the start time is known. Likewise, when the anesthesiologist or nurse leaves the patient for any reason, he or she sweeps the badge 36 past the reader device 22 so that the departure time is recorded.

An example of the room or wall RFID transponder 24 is shown in FIG. 5. This can be mounted on a wall, or on a doorpost at an entry or exit to the room, at a location as is deemed convenient. The wall RFID transponder device is parasitically powered, i.e., does not contain a battery, but simply responds to the interrogation from the reader unit 22. This is also the case for the personal RFID transponder badge.

An example of the patient bed 18 is shown in FIG. 5, illustrating a preferred position of the holder or carrier 20 for the patient reader device 22. Here, the holder 20 is at a foot of the bed, but it is possible to position it elsewhere.

In the present embodiment, a download station 40, e.g., a cradle for holding the reader device 22 (see FIG. 1) is located in the PACU room 16, and this permits the anesthesiology professional to download the data stored on the patient reader device 22 to the computer server 42. The download station connects with the connector port 34 of the reader device 22.

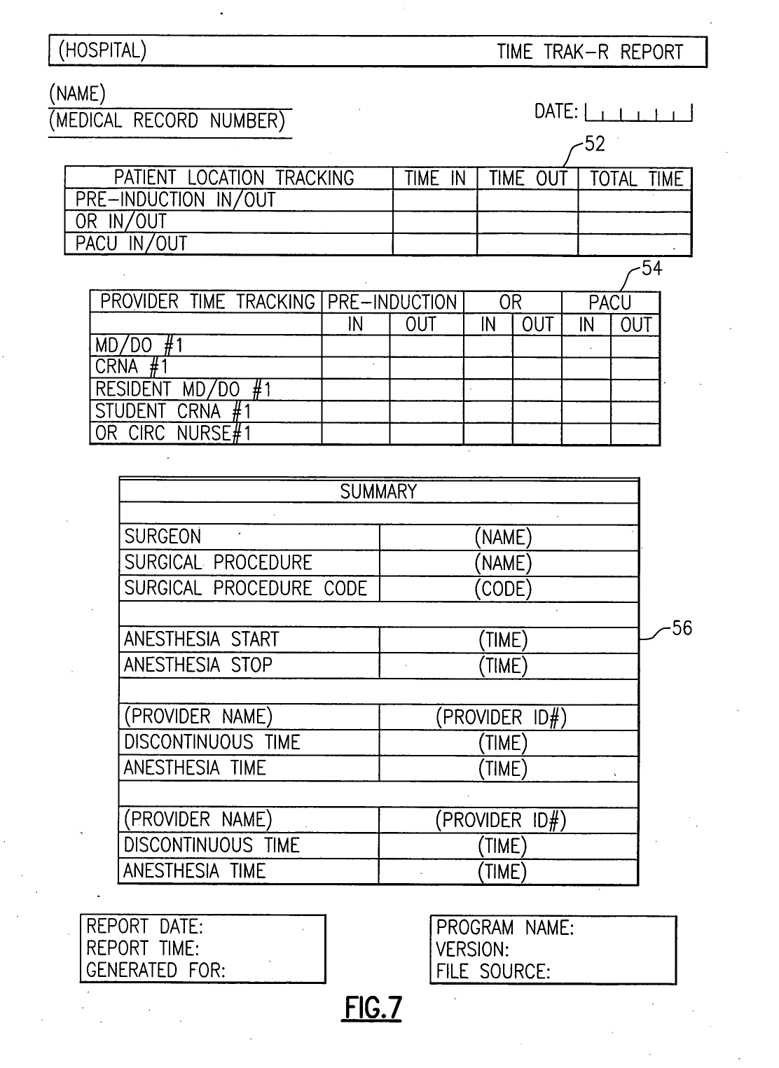

As shown in FIG. 6, the download station also connects with a physician's computer 44, e.g., a laptop computer, in the PACU. This permits the anesthesiologist to review the anesthesiology times and various procedural information for the particular patient, and make corrections as necessary. In this embodiment a laptop computer is shown, the physician could instead use a different computer device, such as a PDA. The server computer 42 interacts with billing software 46, which may be resident on the computer server or another computer, and may transmit the anesthesiology billing data directly (i.e., electronically) to the patient's insurance provider 48.

Also as is shown in FIG. 6, a high-precision clock 50, e.g., an atomic clock, provides precise local time to the main computer server 42. This is used for re-synchronizing each of the patient RFID reader devices 22 at the time of patient data upload and also at the time of download. If wireless communications are employed, the reader devices 22 can be re-synchronized continually. This feature avoids erroneous time entry as between different rooms in the surgical suite as all times are taken from the single high-precision clock 50.

FIG. 7 shows several of the various screens that would be presented on the physician computer 44 or on another computer screen or printer associated with the billing computer server 42. A time patient location and tracking report 52 provides the time in, time our and total time the patient has spent in the pre-induction, OR and PACU locations. Another report 54 provides the identity of the various anesthesiology professionals that may have been involved in the surgical procedure and records the time in and time out of each of those professionals in pre-induction, OR and PACU. A third report 56 lists the identity of the head surgeon, the surgical procedure performed and the surgical procedure code. It also lists the anesthesia start and anesthesia stop times. Additionally, it lists discontinuous time and total (non-discontinuous time) for each anesthesia professional. Discontinuous time is an important data item. Discontinuous time is defined as interim time between the conclusion of anesthesia care in pre-induction and the start time of the surgical procedure upon entry into the operating room is not a billable event. By law, anesthesia is required to bill only for that time spent in pre-induction delivering care and may not bill for discontinuous time. Discontinuous time is so difficult to monitor by hand that many hospital anesthesia departments simply do not record the time and thereby fail to bill for hundreds of thousands of dollars of legally billable events. The times here are stored on the main computer server 42, and can be used for hospital management studies, to track times and efficiencies involved by the various physicians for different types of surgical procedures, and from one surgeon to another. These data can be important in scheduling the operating rooms to maximize room use and minimize patient and surgeon waiting time.

The types or reports, and the fields of entry for each report can be expanded and adjusted as need be, for example, to accommodate a larger or smaller number of professionals or a larger or smaller number of patients, or to included additional fields or non-anesthesiology fields, if needed.

With the system of this invention, the time for each anesthesiologist, certified registered nurse anesthetist (CRNA), or other person, the identity of the head surgeon and surgical procedure performed for each surgical patient are accurately tracked and recorded, eliminating time overlap or other discrepancies that might result in refusal of the insurance provider to honor the hospital bill. The system can be implemented at a reasonable cost and without requiring significant additional training. The system of this invention is actually much simpler to implement, and produces a much lower error rate, than any manual system now in place.

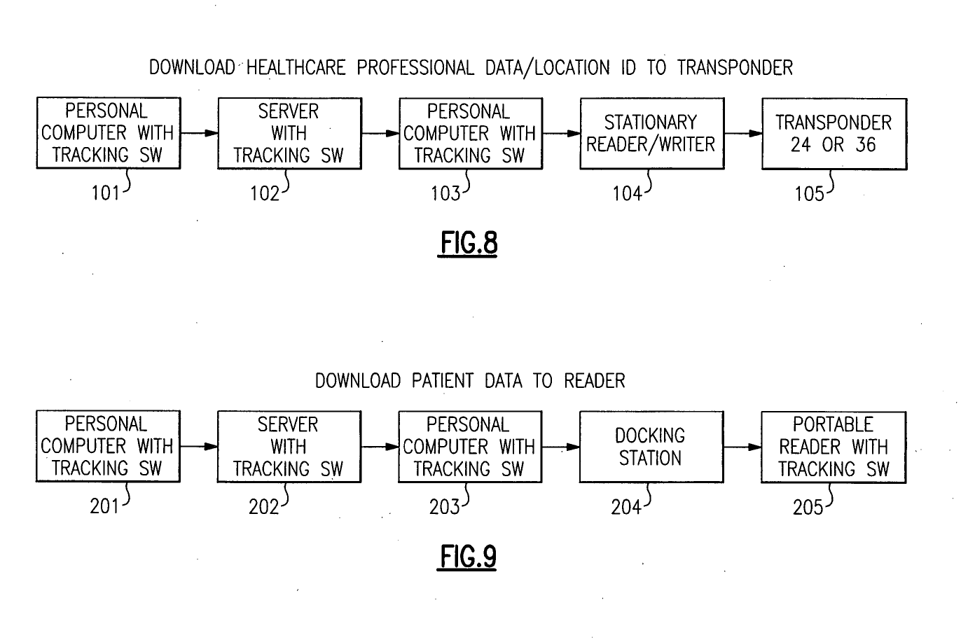

The process of uploading health care professional identification and room location identification and then downloading these data to the transponders 24, 36, can be described with reference to FIG. 8. In step 101, all necessary identifying data for each anesthesia healthcare worker is entered into a computer. Likewise, all the necessary identifying data for each room in the surgical suite regarding the location of the room transponders 24 (e.g., “Pre-Induction-North; Pre-Induction-South, etc.) are entered into the computer. Then (step 102) the data entered in step 101 are sent to a server that contains the tracking software. The data are integrated with the software, and stored on the server. The integrated data are then retrieved by a secure link to another computer (step 103), and the retrieved integrated data are transmitted to a stationary reader/writer that transcribes the data onto respective RFID transponders, which then become the room transponders 24 and the personal transponders 36 (step 104). Then the transponders 24, 36 are placed at the appropriate location or provided to the health care professional (step 105), and they are used thereafter to identify the person or place.

The process of uploading patient information to the associated reader device 22 is described here with reference to FIG. 9. At intake prior to surgery, the patient P provides hospital intake staff or his or her healthcare worker in the Pre-Induction Unit with personal and demographic data and insurance data, and these data are entered into a computer that is loaded with the tracking software (step 201). Then the patient-identifying data entered in step 201 is sent to a server (e.g., 42) that contains the tracking software (step 202). The patient data are integrated with the tracking software, and stored in the server. Then, the integrated patient data are retrieved by a secure link to a personal computer (step 203), that is associated with a docking station (e.g., 40). The docking station serves as a means for transfer of data between the computer and an associated portable reader device 22 that contains the necessary tracking software, and the data are transferred to the docking station (step 204. One of these portable reader devices is placed into the docking station, and the patient data are downloaded into it (step 205). The portable reader device is then placed into the cradle 20 on the patient's rolling bed or gurney, and this device 22 then accompanies the patient P through the entire surgical procedure.

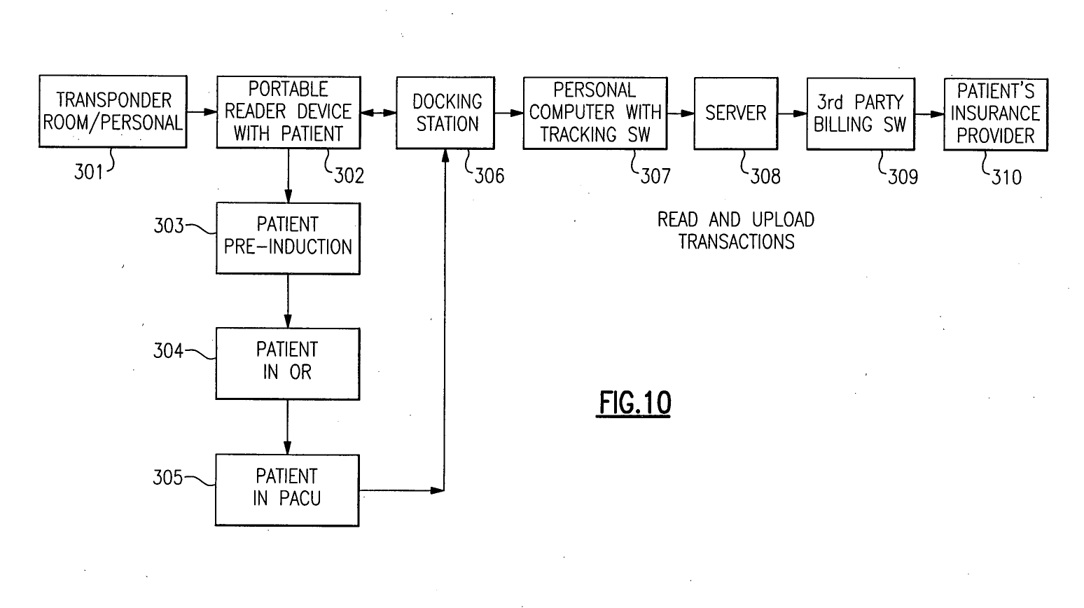

The process of actually tracking the anesthesiologist time throughout the surgical procedure can be explained with reference to FIG. 10. First, each relevant healthcare worker and each relevant location is provided with a suitably and properly encoded RFID transducer 36 or 24 (step 301) as discussed above in reference to FIG. 8, and the patient's portable reader device 22 is properly uploaded with tracking software and with the required patient data (step 302), as discussed above in reference to FIG. 9. The device 22 is attached to the patient's rolling bed or gurney 18, and accompanies the patient P throughout the surgical procedure.

The patient is brought to pre-induction 12 (step 303) where the patient is assigned the portable reader device 22 that has been properly uploaded as discussed in step 302. The reader is presented to one of the peri-operative room RFID transponders 24, thereby noting the patient's location. The reader device 22 will also properly record the time of day at the moment of presentation of the transponder to the reader device. The patient is now “in process.” The anesthesiologist assigned to the patient may then commence anesthesia in the pre-induction area. The anesthesiologist will present his or her personal transponder 36 to the reader device 22, thereby noting the place and time of his or her interaction with the patient. Other information about this interaction may be entered by pushing keys or buttons on the device 36. The patient P may remain in the pre-induction area until the operating room (OR) 14 is ready, or the patient may be taken directly to the OR. If the patient P is caused to wait for a period of time after the anaesthetic has been delivered, the anesthesiologist will present his or her transponder 36 to the patient's reader device 22, thereby noting discontinuous time.

The patient is taken to the operating room 14 (step 304), and the patient reader device 22 continues to track time and place of the various anesthesiology transactions, and the identity of the healthcare professionals, including the anesthesiologist, CRNA, head surgeon, and the type of operative procedure.

The patient P is taken to the OR 14, where the reader 22 is presented to the wall transponder 24, thereby providing accurate, real-time recording of the entry of the patient into the room. As each anesthesiologist, each CRNA, or other identified healthcare worker enters or exits the operating room, he or she will present his or her transponder 36 to the patient's reader device 22, thereby providing accurate real-time recording of the identities of each such person and the time of their entry or exit. If the healthcare worker exits the operating room in which the patient is being treated and enters a second operating room, the healthcare provider will similarly present his or her personal RFID transponder 36 to the second patient's reader device. The identity and location of the healthcare worker will be properly noted, as well as the times of arrival and departure.

The patient's reader device 22 has a search functionality that will allow the anesthesiologist or CRNA to record the identity of the surgeon performing the operative procedure, and the name and billing code of the procedure.

At the completion of the operation, the patient P is removed from the operating room, at which time his or her reader device 22 is presented to the operating room wall transponder 24, noting exit from the OR as well as time of exit.

The patient is brought to the post-anesthesia care unit (PACU) (step 303) where the patient's reader device 22 continues to track location, time, and identity of health care providers present. Upon entry into the PACU 16 or recovery room, the patient's reader device 22 is presented to the PACU wall transponder 24, noting time of arrival at the PACU. Billable anesthesia time ends when the patient is stable and ready for discharge from the PACU. At that time, the completion of this phase is noted on the reader device 22, and the device is placed into a download station for downloading of the data collected during the procedure.

As indicated in step 306, at the conclusion of billable anesthesia time, when the patient P is stable and ready for discharge from the PACU, the anesthesiologist will remove the reader device and place it into a docking station 40, whereupon the data are downloaded from the reader to a personal computer, e.g., 44. Then (step 307), errors in the recorded data, e.g., erroneous billing codes, etc., can be corrected by the anesthesiologist, using an override feature that is incorporated into the tracking software.

Upon completion of all error correction, the data are downloaded to a dedicated server (step 208). The data are encrypted, and comply with all government requirements for accuracy and privacy. Back-up procedures are available in the event of a system failure.

Once the data have been downloaded to the server, the data are available for integration for anesthesia billing and hospital use by properly identified individuals (step 209). The ability to correct errors at this time is also available to suitably identified authorized personnel.

The hospital and/or anesthesia department billing computer then presents accurate and timely billing (step 210) that are forwarded to the patient's insurance carrier for payment. Because the billing is free from the anesthesiology billing errors mentioned earlier that are characteristic of the conventional time tracking procedures, the bills are much easier for the carrier to process, and can be paid out without delay.

While the invention has been described with reference to a preferred embodiment, it should be understood that the invention is not limited only to that embodiment. Rather, many modifications and variations will present themselves to persons of skill in the art without departing from the scope and spirit of this invention, as defined in the appended Claims.

1. System for tracking and recording of billable time of anesthesiology professionals during a surgical procedure with a patient in a surgery suite that includes at least one pre-induction room, at least one surgical operating room, and at least one post-anesthesiology care unit room; and wherein the patient is moved between rooms; comprising
a plurality of handheld portable data collection devices, each including an RFID reader for communicating with a set of RFID transponders, and including means for inputting patient information and type of anesthesiology care being administered to the patient;
a plurality of personal RFID transponders each being assigned to a respective one of said anesthesiology professionals to identify the professional when the transponder is held within a predetermined short distance from a given one of said data collection devices;
a plurality of room RFID transponders, each being mounted on a wall or doorway of a respective one of said pre-induction room; said operating room; and said post-anesthesiology care unit room;
holder means for each patient for removably holding an assigned one of said data collection devices so that the same remains with the patient during the surgical procedure as the patient is moved through the pre-induction, operating, and post-anesthesiology care unit rooms, but can be removed from the holder means to permit the device to be held adjacent the associated room transponders when the patient enters or leaves the room; and
download station into which each of said and-held data collection devices can be placed following completion of the surgical procedure; and including means for downloading stored data from the data collection device to a billing computer to capture times during the procedure that each such anesthesiology professional was present in each said room during the administration of anesthesia care.

2. The system as set forth in claim 1 further comprising means for uploading, into a respective one of said data collection devices, patient data for the associated patient when the patient is in the pre-induction room.

3. The system as set forth in claim 1 further comprising a high-precision clock, and means automatically synchronizing said data collection devices using said high-precision clock.

4. The system as set forth in claim 1 wherein each said data collection device includes a keyboard device adapted to permit the anesthesiology professionals to record identity of head surgeon and surgical procedure being performed.

5. The system as set forth in claim 1 wherein each said data collection device includes a screen for displaying patient data and time plus data relating to the associated patient.

6. A process for tracking and recording billable time of anesthesiology professionals in a surgical suite, which suite includes at least one pre-induction room, at least one surgical operating room, and at least one post-anesthesiology care unit room; and in which surgical patients are wheeled on a bed between rooms of the surgical suite, the process comprising:
assigning to each patient, while in the pre-induction room, a hand-held portable data collection device taken from a plurality of handheld portable data collection devices, each including an RFID reader for communicating with a set of RFID transponders, and including means for inputting patient information and type of anesthesiology event for the patient;
assigning to each of the anesthesiology professionals an RFID transponder from a plurality of personal RFID transponders to identify the professional when the transponder is held within a predetermined short distance from a given one of said data collection devices;
when the patient is taken from a room of the surgical suite, placing the patient data collection device adjacent a room RFID transponder that is mounted on a wall or doorway of such room, so that the device records a time of exit of the patient from the room;
when the patient is brought to a room of the surgical suite, placing the patient data collection device adjacent the room RFID transponder, so that the device records the time of entry of the patient into the room;
when one of the anesthesiology professionals commences to treat a patient, bringing the respective personal RFID transponder adjacent the data collection device to record a start time for such professional with said patient;
when the anesthesiology professional ends his or her treatment of the patient, bringing the respective personal RFID transponder adjacent the data collection device to record an end time for such professional with the patient;
downloading for such patient, from the associated data collection device to a central computer, the data stored in said data collection device to capture times during the procedure that each anesthesiology professional was present for an anesthesiology event.

7. The process according to claim 6, wherein each patient is placed on a bed to permit the patient to be wheeled between rooms of the surgical suite, and further comprising removably placing the patient data collection device into a receptacle therefor on the patient's bed.
